(19) United States
(12) Patent Application Publication
(10) Pub. No.: US 2018/0011675 A1
(43) Pub. Date: Jan. 11, 2018

(54) ELECTRONIC DISPLAY ILLUMINATION

(71) Applicant: Hewlett-Packard Development Company, L.P., Houston, TX (US)

(72) Inventors: Madhu Sudan Athreya, Palo Alto, CA (US); Gang Xu, Palo Alto, CA (US)

(73) Assignee: Hewlett-Packard Development Company, L.P., Houston, TX (US)

(21) Appl. No.: 15/544,971

(22) PCT Filed: Apr. 30, 2015
(86) PCT No.: PCT/US15/28463

§ 371 Date: Jul. 20, 2017

(51) Int. Cl. G06F 3/14; G06F 1/32; G09G 5/14; G09G 5/377; G09G 5/02; G09G 5/10

(52) U.S. Cl. CPC G06F 3/1423; G06F 3/1454; G09G 5/02; G09G 5/10; G09G 5/14; G09G 5/377; G06F 1/3265; G09G 2320/0666; G09G 2320/0686; G09G 2320/08; G09G 2330/021; G09G 2340/12; G09G 2354/00; G09G 2320/0626

(57) ABSTRACT

According to an example, a system for electronic display illumination comprises a display, a sensor communicatively coupled to the display to detect a user and a user eye gaze, and a processing resource communicatively coupled to the sensor. In some examples, the processing resource may determine an active screen area and an inactive screen area of the display based on the user eye gaze; instruct a display controller to adjust a display value of the inactive screen area; and transmit active screen area data to a secondary display.

### BACKGROUND

Electronic devices in the consumer, commercial, and industrial sectors may output video to displays, monitors, screens, and other devices capable of displaying visual media or content. Users may wish to serve as a moderator and transmit, replicate, or share content from one display to another, and may also wish to conserve power resources on a display.

### BRIEF DESCRIPTION OF THE DRAWINGS

FIGS. 1A-C illustrate a device for adjusting display illumination and transmitting content based on an eye gaze, according to an example of the present disclosure;

FIGS. 2A-C illustrate a device for adjusting display illumination based on an eye gaze, according to an example of the present disclosure;

FIG. 3 is a flowchart for altering an inactive screen area based on an eye gaze, according to an example of the present disclosure; and

FIG. 4 illustrates a schematic representation of a computing device that may be used as a platform for implementing or executing at least one of the processes depicted herein, according to an example of the present disclosure.

### DETAILED DESCRIPTION

Various examples described below provide for displaying, transmitting, replicating, and/or sharing display content based on a user eye gaze, such as a teacher in a classroom setting sharing content with students, or a speaker in a business environment sharing content with audience members, or a user serving as a moderator in general. Various examples described below also provide for improving display power management and/or reducing distractions by adjusting various display values and/or re-mapping display images or content based on a user eye gaze, including through local dimming on a backlight.

Generally, an electronic device such as a desktop computer, laptop computer, tablet, mobile device, retail point of sale device, or other device (hereinafter “device”) may connect to or communicate with a display, monitor, or screen (hereinafter “display”) to display content generated or output from the device. In some examples, the device may output content to multiple displays, such as in a dual panel setup. The device may render content, which may be further processed by, for example, a display controller embedded in a display.

According to some examples, the device may also connect to or communicate with other devices or displays to display content. In the example of a business presentation, a moderator's device such as a desktop computer may display content, such as windows of various software applications, which may be shared or replicated onto, for example, laptops of audience members in the classroom.

In such an example, the moderator's device may display multiple windows, such as a word processing document, a video, a spreadsheet, and/or a chart, and such windows may be displayed on a single display or across multiple displays at the direction of the moderator. A moderator may wish to share or replicate one of the windows or screen areas to audience members for display on their devices, or just the windows and/or desktop of one of the moderator's multiple displays. The moderator may also wish to frequently change the screen area, window, or content displayed to the audience members based on the moderator's shifting focus area or region of interest, without the need to input such changes via a mouse or other physical input device.

In such an example, a moderator may also wish to conserve power, either on the moderator's displays, or the displays of the audience members. For example, if a moderator's display is displaying multiple windows, but the moderator is focused on a particular screen area, window, or region of interest, the moderator may wish to dim or turn off the inactive areas of the moderator's display, and/or the audience member displays. Power saving may be especially important in the case of mobile displays where the power draw of a display is a major component of battery drain, and in the case of fixed displays of large size that have substantial power draws.

In another example, the moderator may wish to change the content displayed in the inactive areas on the displays to focus attention on an active window or screen area and reduce distractions from inactive windows or screen areas, and to reduce eye strain.

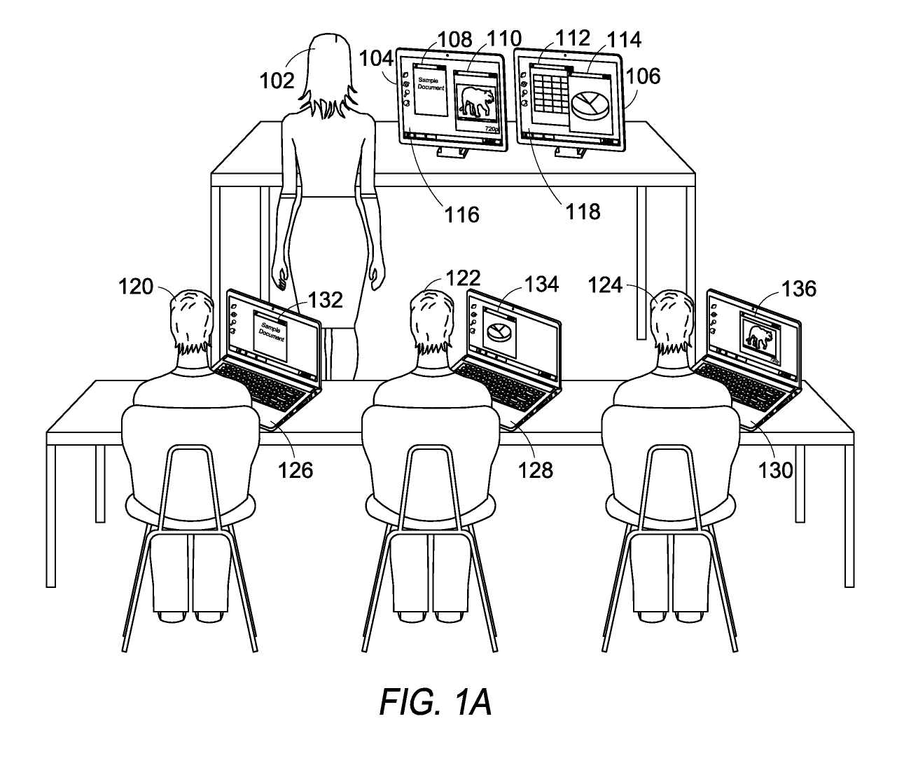

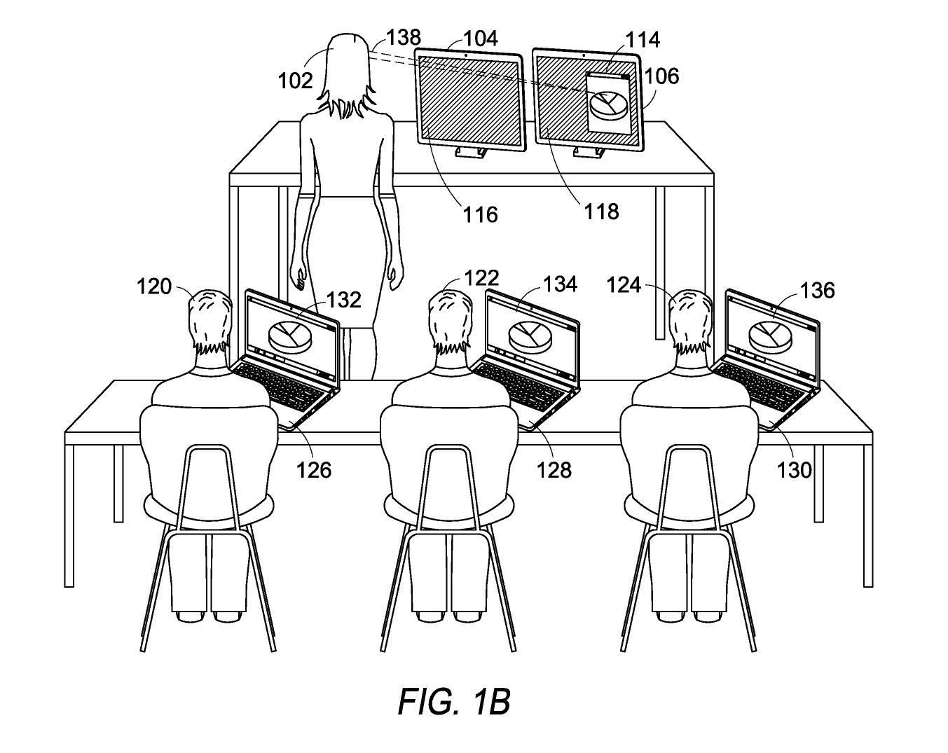

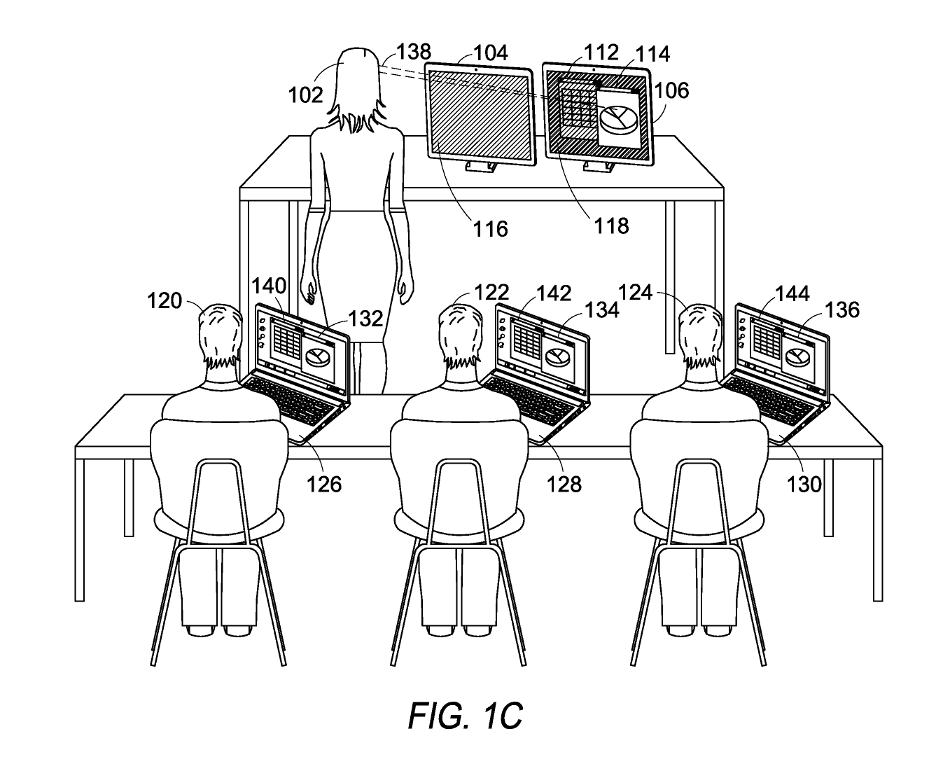

FIGS. 1A-C illustrate a device for adjusting display illumination and transmitting content based on an eye gaze, according to an example of the present disclosure.

In the example of FIG. 1A, a primary or authorized user 102 may be positioned in front of a display 104 and/or display 106. As discussed above, user 102 may be a moderator, instructor, teacher, presenter, or generally a user of a device attached to display 104 and/or 106. As discussed above, a device attached to display 104 and/or 106 may be a computing device, and may render content for display on display 104 and/or 106.

Displays 104 and/or 106 may be a light emitting diode (“LED”) display, an organic light emitting diode (“OLED”) display, a projector, a mobile display, a holographic display, or any other display type capable of displaying an image or content from an electronic device.

Displays 104 and 106 may display an operating system desktop 116 and 118 with a taskbar and windows or screen areas 108, 110, 112, and 114. The display may also be coupled to a keyboard and mouse, or other devices or peripherals. Displays 104 and/or 106 may also comprise a camera, LED, or other sensor for detecting a user or users, distances between users and the displays, locations of users, and eye gazes. In some examples, the sensor may be mounted within the bezel of the display, as shown in FIG. 1A, or may be mounted or located on another part of the display, or auxiliary to the display.

In the example of FIG. 1A, user 102 may be detected by a sensor that may be, as examples, an HD RGB-IR sensor, an HD RGB (or black and white) CMOS sensor and lens, an IR LED, or any combination of sensors to detect eye gaze. As discussed below in more detail, the sensor may detect the location and distance between the displays 104 and/or 106 and user 102, as well as the user's eye gaze.

In the example of FIG. 1A, secondary users 120, 122, and 124 may be located near primary user 102, while in other examples, secondary users may be located remotely from user 102 and/or displays operated by user 102. In the example of FIG. 1A, users 120, 122, and 124 may be audience members or students receiving content on their respective devices, e.g., laptops 132, 134, and 136, from displays 104 and/or 106.

More specifically, in the example of FIG. 1A, laptop 126 of user 120 is displaying window 132 which mirrors window 108; laptop 128 of user 122 is displaying window 134 which mirrors window 114; and laptop 130 of user 124 is displaying window 136, which mirrors window 110. In this example, the secondary users 120, 122, and 124 may have control over which windows from displays 104 and/or 106 they are viewing, or the primary user 102 may have assigned a particular window or screen area to be displayed to each of the secondary users 120, 122, and 124, as shown in FIG. 1A.

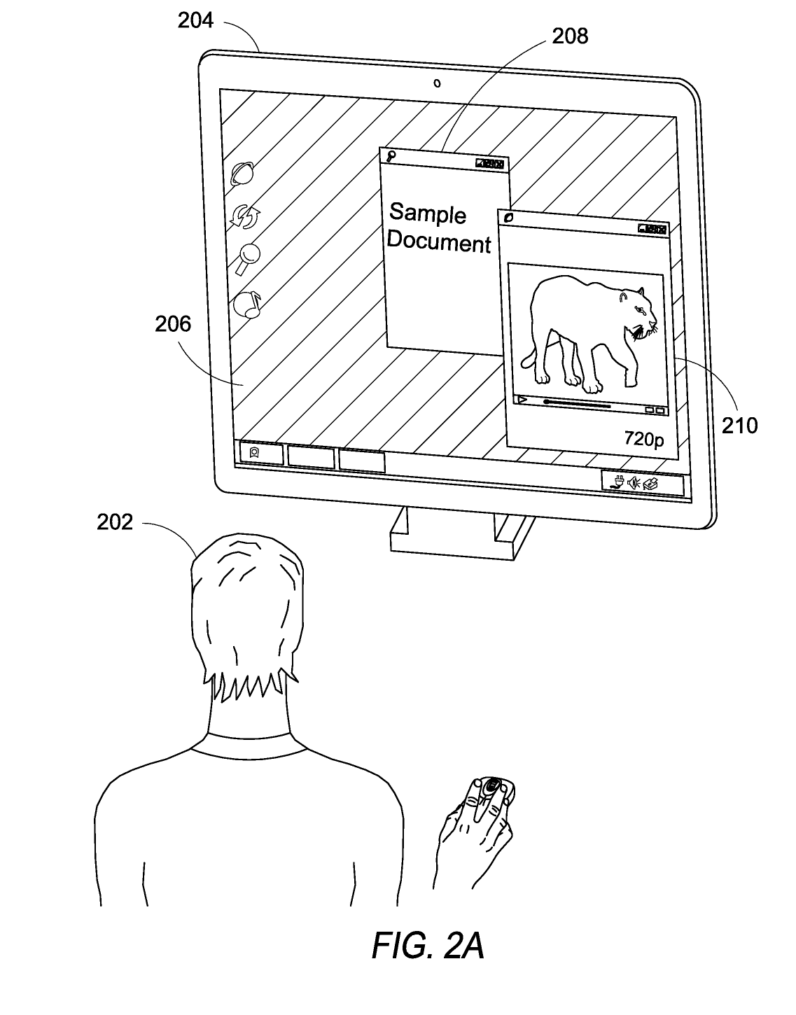

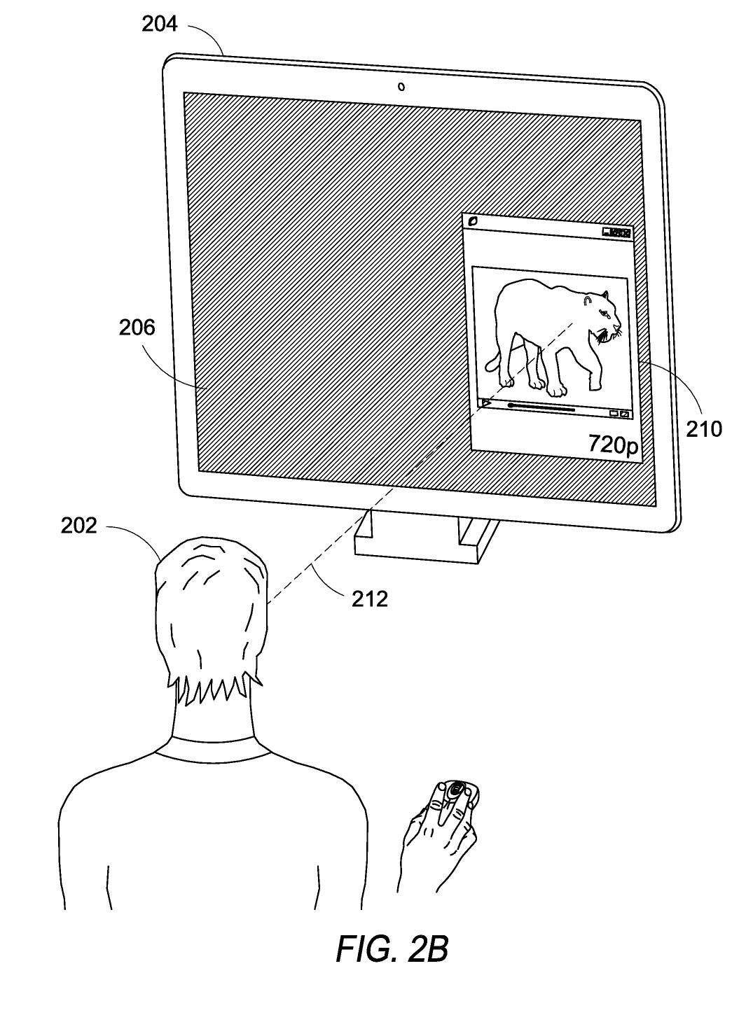

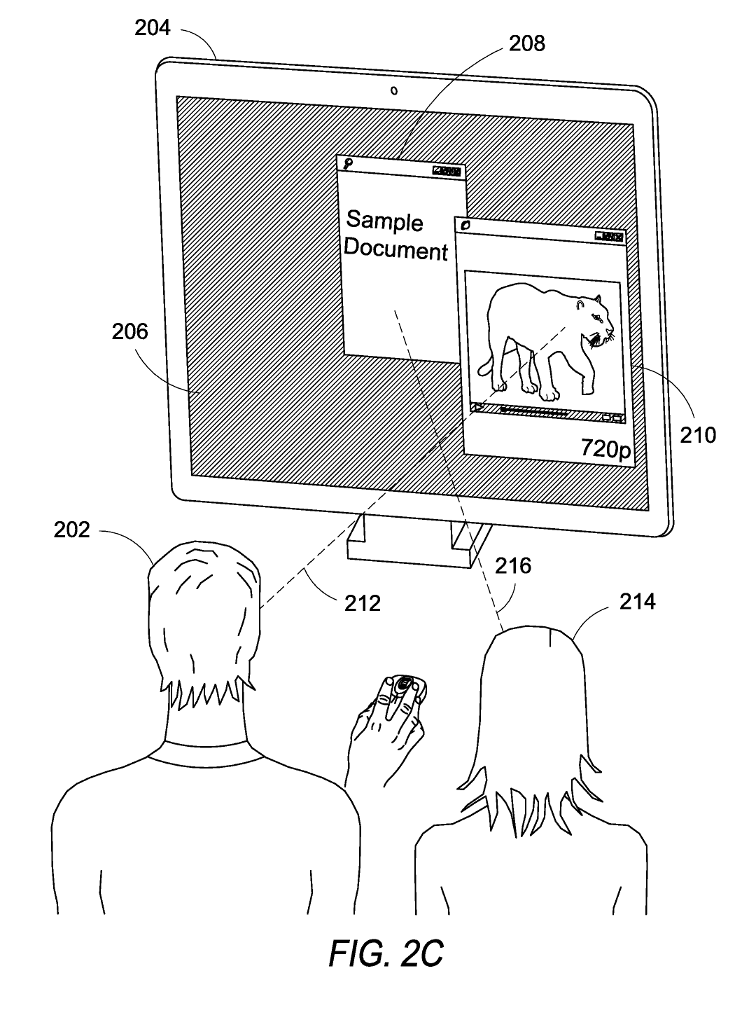

In the example of FIG. 1B, a sensor or sensors disposed on or communicatively coupled to displays 104 and/or 106 has detected the eye gaze of user 102 toward window 114 on display 106. In this example, window 106 may be identified as an active window or screen area, region of interest, or focus area, while the remainder of display 106 and all of display 104 may be identified as inactive screen areas. The inactive screen areas may be dimmed, turned off, or otherwise remapped or re-imaged as discussed below in more detail with respect to FIGS. 2A-C.

In such an example, window 106 may be displayed full-screen on the devices 126, 128, and 130 of users 120, 122, and 124 as windows 132, 134, and 136. In other examples, the windows 132, 134, and 136 may mirror the relative size and relative location of window 114 on display 106, or may be selectively controllable by users 120, 122, and 124.

In the example of FIG. 1C, a sensor or sensors disposed on or communicatively coupled to displays 104 and/or 106 has detected the eye gaze of user 102 toward window 114 on display 106. In this example, as above, window 106 may be identified as an active window or screen area, region of interest, or focus area, while the remainder of display 106 and all of display 104 may be identified as inactive screen areas. In contrast to FIG. 1B, however, window 112, which is adjacent to window 114, may remain powered on or slightly dimmed, or not dimmed as much as the remainder of the inactive screen areas.

In such an example, window 106 may be displayed on devices 126, 128, and 130 of users 120, 122, and 124 as windows 132, 134, and 136, along with the remainder of the content displayed on display 106. In some examples, the content displayed on laptop displays 126, 128, and 130 may be displayed with the inactive screen areas of display 106 powered on and at full brightness, while in other examples the displays of devices 126, 128, and 130 may mirror display 106.

FIGS. 2A-C illustrate a device for adjusting display illumination based on an eye gaze, according to an example of the present disclosure. In FIG. 2A, user 202 may be positioned near display 204, which may display a desktop operating system 206 including windows and/or screen areas 208 and 210. As discussed above, display 204 may include a sensor for tracking a user eye gaze, such as the sensor shown in the top bezel of display 204. In FIG. 2A, the desktop background of display 204 may be any desktop background such as a default operating system background, or a background chosen by a user, as represented by cross-hatching.

In FIG. 2B, the sensor of display 204 may have detected a user eye gaze toward window 210. In such an example, the inactive screen area, e.g., the remainder of display 204, may be altered as represented by the cross-hatching of FIG. 2B.

In one example, the inactive screen area of display 206 may be turned off, i.e., a device attached to display 206 may instruct a display controller of display 206 to adjust a backlight, OLED, or other illumination component to disable or power off the inactive screen area, e.g., at a region level, grid level, or pixel level. In another example, the inactive screen area of display 204 may be dimmed, but not turned off.

In an example of an LED display, to enable local dimming, an input image may be analyzed by a processer and optimized backlight illumination patterns may be generated based on the calibrated data from the backlight illumination patterns from each of the independent LCD strings. The display image may then be remapped based on the original image and the backlight illumination pattern. A spatial profile may be used as input to the local dimming analysis.

In other examples, the inactive screen area may remain powered on, but may be altered such as by adjusting a color saturation, contrast level, or other display property of the inactive screen area to focus a user's attention on the active screen area, e.g., window 210 in the example of FIG. 2B.

According to other examples, a peripheral area of the screen outside of the active screen area may be determined, with a change to the color saturation, contrast level, or other display property applied accordingly, e.g., as a gradient toward the extreme edge of the periphery. In such examples, the overall brightness average of the screen may be lowered, resulting in power savings.

According to another set of examples, a pattern may be applied to the inactive screen area or the peripheral areas outside the active screen area. Examples of such patterns may include geometric patterns, radial patterns and/or grid patterns, photos, or other patterns or images to focus a user's attention toward an active screen area. Applying a pattern may include re-mapping an image based on, for example, a backlight unit illumination pattern and the original image, factoring in any constraints of the backlight. Patterns or images may also be selected from a database based on input such as the active screen area window type, color saturation, or other properties of the active or inactive screen areas.

In some examples, to improve user experience, a temporal profile may be determined or fetched to minimize or transition the impact of a change in power state, brightness, color saturation, contrast level, other display property, pattern application, or re-mapping. In other examples, a spatial profile may be determined, e.g., based on signal processing, or fetched to minimize flashing or halo effects. In other examples, temporal profiles and/or spatial profiles may be combined with a user interface design rule to determine an appropriate delta between a brightness level of an active screen area and an inactive screen area, or whether center-to-edge shading should be applied, as examples.

In some examples, a minimum time interval, such as a power-save time interval, may also be enforced. For example, an active screen area, region of interest, or focus area may be determined once an eye gaze has been detected on a particular screen area for a minimum amount of time without interruption. In the example of FIG. 2B, the active screen area 210 may be detected as the active screen area once user 202 has remained with a constant eye gaze on window 210 for 10 seconds.

In the example of FIG. 2C, a second user 214 has been detected by a sensor of display 204, and an eye gaze 216 of user 214 has been detected toward window 208. Windows 208 and 210 may be determined to be active screen areas, and may remain unaltered while the inactive screen area is subjected to changes in power state, brightness, color saturation, contrast level, other display property, pattern application, or re-mapping, as discussed above.

According to another example, a second display may be added to the monitor configuration of FIG. 2A. In such an example, if an active screen area is detected on display 204, the entire second display may be determined to be an inactive screen area and adjusted accordingly.

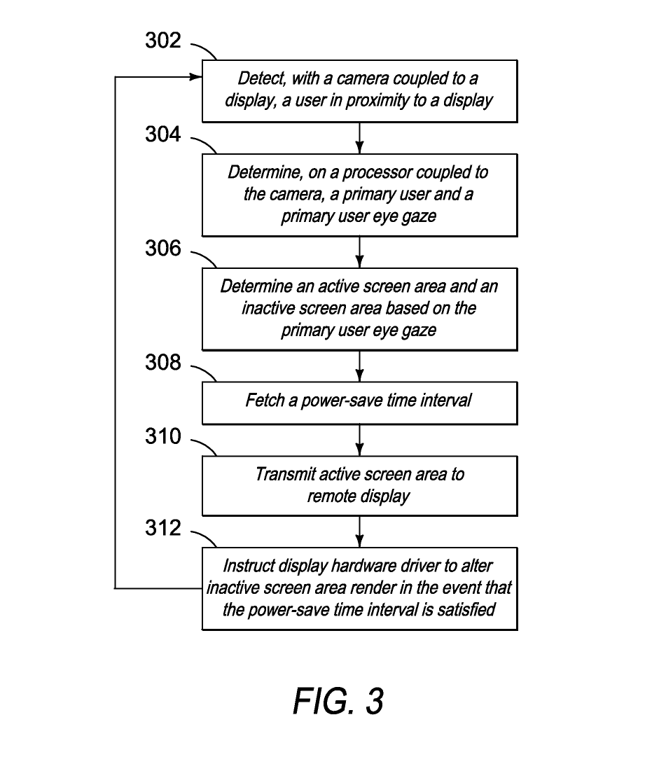

FIG. 3 is a flowchart for altering an inactive screen area based on an eye gaze, according to an example of the present disclosure.

In block 302, a camera or other sensor coupled to a display may detect a user in proximity to the display. In block 304, a processing resource, e.g., a processor, coupled to the camera may determine a primary user and a primary user eye gaze.

In block 306, an active screen area and an inactive screen area are determined based on the primary user eye gaze. In block 308, a power-save time interval is fetched.

In block 310, an active screen area is transmitted to a remote display. In block 312, a display hardware driver is instructed to alter an inactive screen area render in the event that the power-save time interval is satisfied. Altering the inactive screen area may comprise altering a power state, brightness, color saturation, contrast level, other display property, pattern application, or re-mapping, as discussed above.

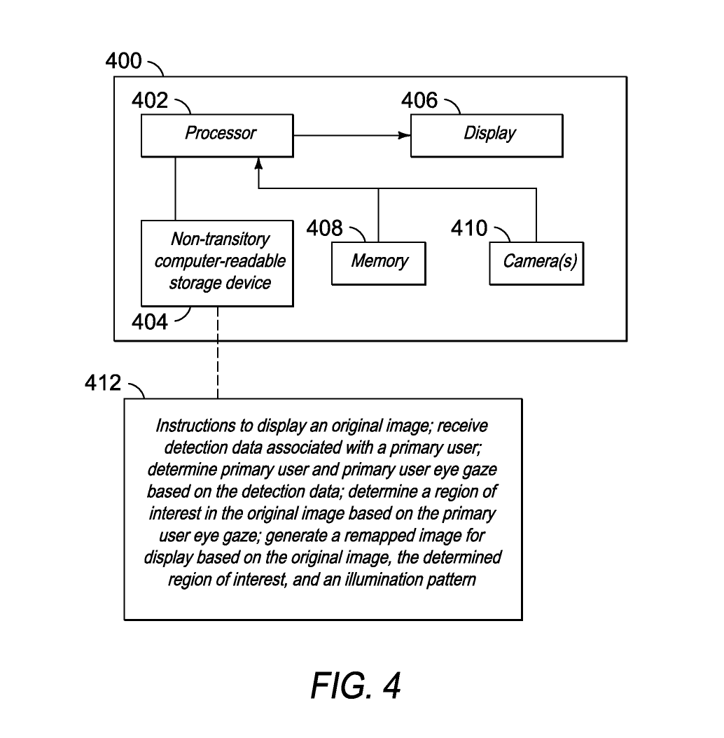

FIG. 4 illustrates a schematic representation of a computing device that may be used as a platform for implementing or executing at least one of the processes depicted herein, according to an example of the present disclosure.

In an example, device 400 comprises a processing resource such as processor or CPU 402; a non-transitory computer-readable storage medium 404, a display controller 406, a memory 408, and a camera or other sensor 410. In some examples, device 400 may also comprise a memory resource such as memory, RAM, ROM, or Flash memory; a disk drive such as a hard disk drive or a solid state disk drive; an operating system; and a network interface such as a Local Area Network LAN card, a wireless 802.11x LAN card, a 3G or 4G mobile WAN, or a WiMax WAN card. Each of these components may be operatively coupled to a bus.

Some or all of the operations set forth in the figures may be contained as a utility, program, or subprogram in any desired computer readable storage medium, or embedded on hardware. The computer readable medium may be any suitable medium that participates in providing instructions to the processing resource 402 for execution. For example, the computer readable medium may be non-volatile media, such as an optical or a magnetic disk, or volatile media, such as memory. The computer readable medium may also store other machine-readable instructions, including instructions downloaded from a network or the internet.

In addition, the operations may be embodied by machine-readable instructions. For example, they may exist as machine-readable instructions in source code, object code, executable code, or other formats.

Device 400 may comprise, for example, a computer readable medium that may comprise instructions 412 to display an original image; receive detection data associated with a primary user; determine a primary user and a primary user eye gaze based on the detection data; determine a region of interest in the original image based on the primary user eye gaze; and generate a remapped image for display based on the original image, the determined region of interest, and an illumination pattern.

The computer-readable medium may also store an operating system such as Microsoft Windows, Mac OS, Unix, or Linux; network applications such as network interfaces and/or cloud interfaces; and a cloud service, monitoring tool, or metrics tool, for example. The operating system may be multi-user, multiprocessing, multitasking, and/or multithreading. The operating system may also perform basic tasks such as recognizing input from input devices, such as a keyboard or a keypad; sending output to a display; keeping track of files and directories on a medium; controlling peripheral devices, such as drives, printers, or image capture devices; and/or managing traffic on a bus. The network applications may include various components for establishing and maintaining network connections, such as machine readable instructions for implementing communication protocols including, but not limited to, TCP/IP, HTTP, Ethernet, USB, and FireWire.

In certain examples, some or all of the processes performed herein may be integrated into the operating system. In certain examples, the processes may be at least partially implemented in digital electronic circuitry, in computer hardware, in machine readable instructions, or in any combination thereof.

The above discussion is meant to be illustrative of the principles and various examples of the present disclosure. It is intended that the following claims be interpreted to embrace all such variations and modifications.

What is claimed is:

1. A system for electronic display illumination, comprising:
a display;
a sensor communicatively coupled to the display to detect a user and a user eye gaze; and
a processing resource communicatively coupled to the sensor,
wherein the processing resource is to determine an active screen area and an inactive screen area of the display based on the user eye gaze, instruct a display controller to adjust a display value of the inactive screen area, and transmit active screen area data to a secondary display.

2. The system of claim 1, wherein the display controller is coupled to a backlight.

3. The system of claim 1, wherein the display controller is coupled to at least one organic light-emitting diode.

4. The system of claim 1, wherein the display value is a brightness level.

5. The system of claim 1, wherein the display value is a color saturation level.

6. The system of claim 1, wherein the display controller is further to adjust a display value of a peripheral area of the active screen area.

7. The system of claim 1, wherein the display controller is to transition the display value.

8. The system of claim 7, wherein the transition is based on a temporal profile.

9. A method of adaptive electronic display illumination, comprising:
detecting, with a camera coupled to a display, a user in proximity to the display;
determining, on a processor coupled to the camera, a primary user and a primary user eye gaze;
determining an active screen area and an inactive screen area based on the primary user eye gaze;
fetching a power-save time interval;
transmitting the active screen area to a remote display; and
in the event that the power-save time interval is satisfied, instructing a display hardware driver to alter a rendering of the inactive screen area.

10. The method according to claim 9, wherein altering the inactive screen area rendering comprises overlaying a pattern onto inactive screen area content.

11. The method according to claim 9, wherein altering the inactive screen area rendering comprises a transition based on a temporal profile.

12. The method according to claim 9, wherein altering the inactive screen area rendering comprises loading a spatial profile.

13. A non-transitory computer readable storage medium on which is stored a computer program for adjusting electronic display illumination, said computer program comprising a set of instructions to:
display an original image;
receive, from a sensor, detection data associated with at least one user of a display;
determine a primary user and a primary user eye gaze based on the detection data;
determine a region of interest in the original image based on the primary user eye gaze; and
generate a remapped image for display,
wherein the remapped image is based on the original image, the determined region of interest, and an illumination pattern.

14. The computer readable storage medium of claim 13, wherein the illumination pattern comprises an adjustment to the original image.

15. The computer readable storage medium of claim 13, wherein the illumination pattern is selected from a database based on the content of the region of interest.
